(19) United States
(12) Patent Application Publication
(10) Pub. No.: US 2025/0340311 A1
(43) Pub. Date: Nov. 6, 2025

(54) Component Health Monitoring

(71) Applicant: The Boeing Company, Arlington, VA (US)

(72) Inventors: Kangyu Ni, Calabasas, CA (US); Alice A. Murphy, Mesa, AZ (US); Tsai-Ching Lu, Thousand Oaks, CA (US); Douglas Peter Knapp, West Chester, PA (US)

(21) Appl. No.: 18/655,629

(22) Filed: May 6, 2024

(51) Int. Cl. B64F 5/60; G06N 3/04

(52) U.S. Cl. CPC B64F 5/60; G06N 3/04

(57) ABSTRACT

A method for monitoring a health of generator bearings. Sensor data is identified for a set of variables from a sensor system monitoring a generator including the generator bearings. Condition indicator data for a set of condition indicators for the generator bearings is identified. The sensor data is input into an input layer in layers in a neural network. The condition indicator data is input into a last layer before an output layer in the layers in the neural network. The neural network is trained to predict a health status of the generator bearings using the sensor data for the set of variables and the condition indicator data for the set of condition indicators. A prediction of the health status for the generator bearings is received from the output layer in response to inputting the sensor data and the condition indicator data.

### BACKGROUND INFORMATION

### 1. Field

The present disclosure relates generally to health monitoring for aircraft components and in particular, to performing health monitoring of aircraft components using neural networks.

### 2. Background

Health monitoring is performed for aircraft to increase safety, increase operational efficiency, and reduce costs. This monitoring can be performed for aircraft components. This monitoring can be for aircraft components such as generators, engines, avionics systems, and other components. This monitoring can be performed continuously during operation of an aircraft.

With this type of monitoring, potential inconsistencies or out of tolerance operations of aircraft components can be detected. By detecting these potential inconsistencies or out of tolerance operations, maintenance can be performed prior to an aircraft being out of a desired operating tolerance. Further, this type of monitoring can also be used by airlines to make decisions about fleet management, component replacement, operational planning, and other actions regarding aircraft.

### SUMMARY

An embodiment of the present disclosure provides a generator health monitoring system for a generator. The generator bearing health monitoring system comprises a computer system, neural network in the computer system, and health analyzer in the computer system. The neural network comprises layers, an input layer in the layers in the neural network, and a last layer before an output layer in the layers in the neural network. The input layer is configured to receive sensor data for a set of variables for generator bearings in the generator. The last layer is configured to receive condition indicator data for a set of condition indicators. The neural network is trained to predict a health status of the generator bearings using the sensor data for the set of variables and the condition indicator data for the set of condition indicators. The health analyzer is configured to identify the sensor data for the set of variables from a sensor system monitoring the generator including the generator bearings; identify the condition indicator data for the set of condition indicators for the generator bearings; input the sensor data into the input layer; input the condition indicator data into the last layer; and receive the prediction of the health status of the generator bearings from the output layer for the neural network in response to inputting the sensor data and the condition indicator data.

An embodiment of the present disclosure provides a health monitoring system comprising a computer system, a neural network in the computer system, and a health analyzer in the computer system. The neural network comprises layers, an input layer in the layers in the neural network, and a subsequent layer in the layers in the neural network. The input layer is configured to receive sensor data for a set of variables for a component. The subsequent layer is configured to receive condition indicator data for a set of condition indicators. The neural network is trained to predict a health status of the component using the sensor data for the set of variables and the condition indicator data for the set of condition indicators. The health analyzer is configured to: input the sensor data into the input layer; input the condition indicator data into the subsequent layer; and receive the health status predicted for the component from the output layer in response to inputting the sensor data and the condition indicator data.

Yet another embodiment of the present disclosure provides a method for monitoring a health of generator bearings. Sensor data is identified for a set of variables from a sensor system monitoring a generator including the generator bearings. Condition indicator data for a set of condition indicators for the generator bearings is identified. The sensor data is input into an input layer in layers in a neural network. The condition indicator data is input into a last layer before an output layer in the layers in the neural network. The neural network is trained to predict a health status of the generator bearings using the sensor data for the set of variables and the condition indicator data for the set of condition indicators. A prediction of the health status for the generator bearings is received from the output layer in response to inputting the sensor data and the condition indicator data.

Still another embodiment of the present disclosure provides a method for monitoring a health of a component. Sensor data for a set of variables for the component is input into an input layer in layers in a neural network. Condition indicator data for a set of condition indicators is input into a subsequent layer before an output layer in the layers in the neural network. The neural network is trained to predict a health status of the component using the sensor data for the set of variables and the condition indicator data for the set of condition indicators. The health status predicted for the component is received from the output layer in response to inputting the sensor data and the condition indicator data.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a health monitoring environment in accordance with an illustrative embodiment;

FIG. 3 is an illustration of a dataflow for training and using a physics informed neural network in accordance with an illustrative embodiment;

FIG. 4 is an illustration of a diagram of training a physics informed neural network in accordance with an illustrative embodiment;

FIG. 5 is an illustration of a diagram of training a physics informed neural network in accordance with an illustrative embodiment;

FIG. 6 is an illustration of a flowchart of a process for monitoring the health of a component in accordance with an illustrative embodiment;

FIG. 7 is an illustration of a flowchart of a process for generating sensor data in accordance with an illustrative embodiment;

FIG. 8 is an illustration of a flowchart of a process for performing a set of actions in accordance with an illustrative embodiment;

FIG. 9 is an illustration of a flowchart of a process for training a neural network to monitor the health of a component in accordance with an illustrative embodiment;

FIG. 10 is an illustration of a flowchart of a process for monitoring the health of generator bearings in accordance with an illustrative embodiment;

FIG. 11 is an illustration of a flowchart of a process for generating sensor data in accordance with an illustrative embodiment;

FIG. 12 is an illustration of a flowchart of a process for performing a set of actions in accordance with an illustrative embodiment;

FIG. 13 is an illustration of a block diagram of a data processing system in accordance with an illustrative embodiment;

FIG. 14 is an illustration of an aircraft manufacturing and service method in accordance with an illustrative embodiment; and

FIG. 15 is an illustration of a block diagram of an aircraft in which an illustrative embodiment may be implemented.

### DETAILED DESCRIPTION

The illustrative embodiments recognize and take into account one or more different considerations as described herein. For example, currently used condition-based maintenance methods for aircraft components are based on statistics and trending and leverage domain experts and failure instances to establish thresholds. The experts select the relevant data to implement condition indicators. Further, the current techniques do not use a neural network. In addition, current techniques do not incorporate expert knowledge with the model. This expert knowledge can include a selection of condition indicators that may be helpful in predicting the health of an aircraft component.

A machine learning model such as a neural network can be created that takes into account both the sensor data for the aircraft component and expert knowledge. In these illustrative examples, the expert knowledge takes the form of condition indicators that have been identified as useful in determining the health of aircraft components but are not definitive for use in determining the health of the aircraft components.

In one illustrative example, analog data is sampled with high frequency in the form of multivariate time series in an aircraft component such as generator bearings in a generator. This data is sensor data for a set of variables relating to the generator bearings. The sensor data is used to determine health status using a neural network. Further, physics knowledge about the generator bearings is also input into the neural network. This physics knowledge takes the form of condition indicators data for a set of condition indicators.

In this example, the neural network uses the sensor data and the condition indicator data as inputs and outputs as a health classification for generator bearings in the generator using this data. In one illustrative example, this health classification can be a determination of whether the generator bearings have grease or a lack of grease.

The illustrative examples provide a method, apparatus, system, and computer program product for performing health monitoring. In the illustrative examples, a physics informed deep learning approach can be used to train machine learning models such as neural networks to predict the health of aircraft components. These aircraft components can include generators, engines, landing gear, computer systems, structures, and other aircraft components. In one illustrative example, a physics informed deep learning approach can be used to leverage sensor data and embed physics knowledge of generator bearings into training machine learning model such as a neural network.

For example, with respect to a component such as generator bearings, a generator bearing health monitoring system comprises a computer system, neural network in the computer system, and health analyzer in the computer system. The neural network comprises layer, an input layer in the layers, and a last layer before an output layer in the layers. The input layer is configured to receive sensor data for a set of variables for generator bearings in the generator. The last layer is configured to receive condition indicator data for a set of condition indicators. The neural network is trained to predict a health status of the generator bearings using the sensor data for the set of variables and the condition indicator data for the set of condition indicators.

The health analyzer is configured to receive the sensor data for the set of variables from a sensor system monitoring the generator including the generator bearings; receive the condition indicator data for the set of condition indicators for the generator bearings; input the sensor data into the input layer; input the condition indicator data into the last layer; and receive the prediction of the health status of the generator bearings from the output layer for the neural network.

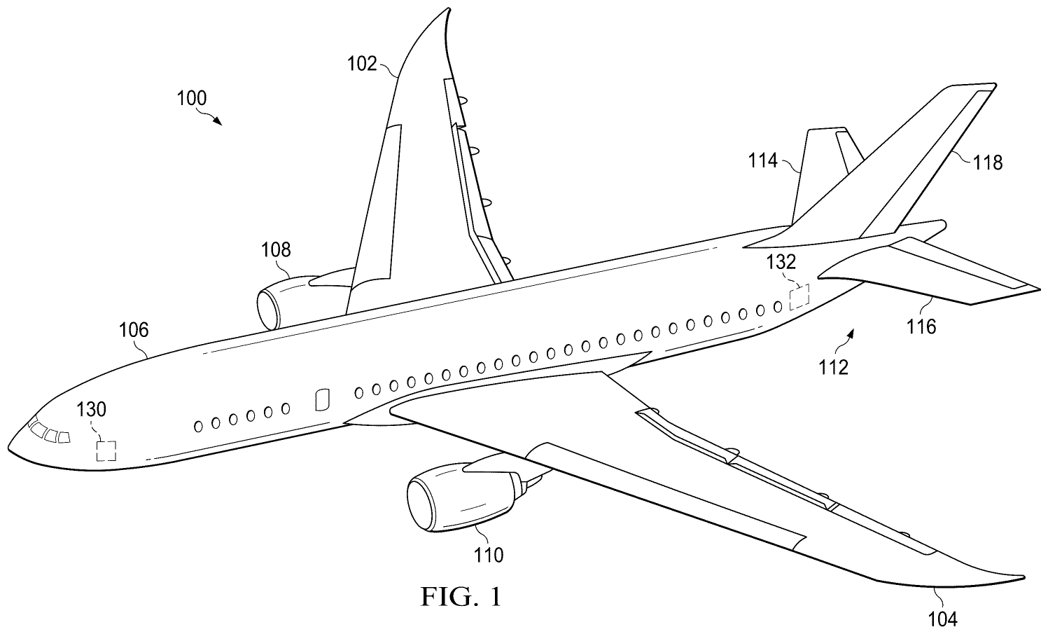

With reference now to the figures, and in particular, with reference to FIG. 1, an illustration of an aircraft is depicted in accordance with an illustrative embodiment. In this illustrative example, aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft in which health monitoring system 130 can be implemented in accordance with an illustrative embodiment. In this illustrative example, health monitoring system 130 can monitor the health of various aircraft components in aircraft 100. This monitoring can be performed continuously, periodically, or in response to events.

For example, health monitoring system 130 can operate to continuously monitor the health of generator 132. Generator 132 can be an auxiliary power unit for aircraft 100. In this example, health monitoring system 130 can monitor the health of generator bearings in generator 132.

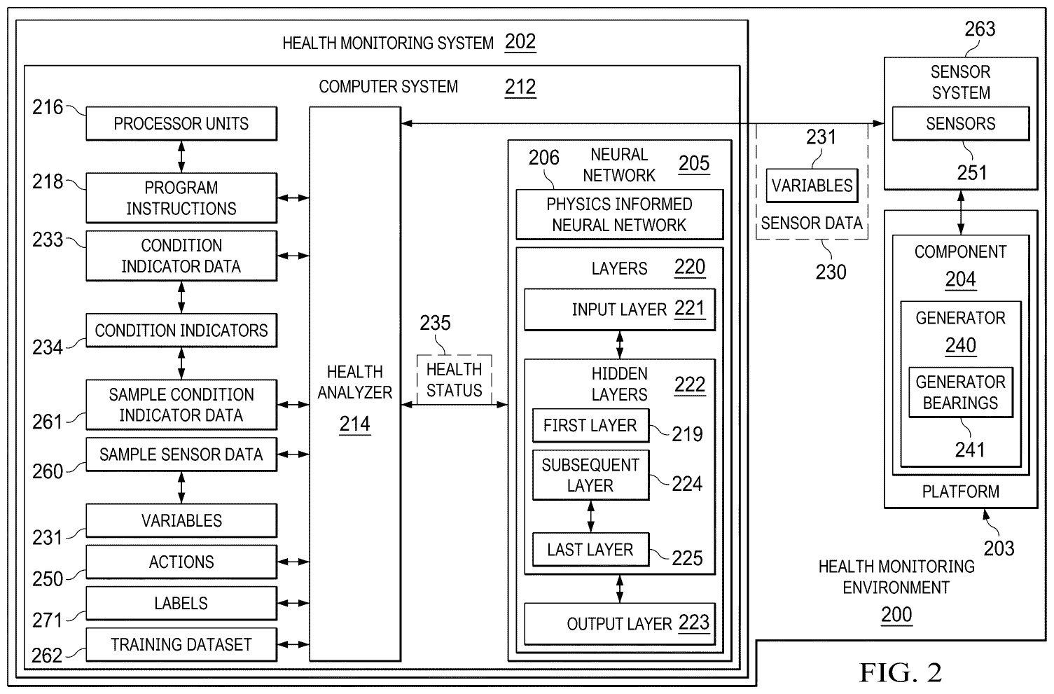

With reference now to FIG. 2, an illustration of a block diagram of a health monitoring environment is depicted in accordance with an illustrative embodiment. In this illustrative example, health monitoring environment 200 includes components that can be implemented in health monitoring system 130 in aircraft 100 in FIG. 1.

As depicted, health monitoring system 202 can operate to monitor platform 203. Platform 203 can take a number of different forms. For example, platform 203 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, a building, or other types of platforms.

As used herein, “a number of” when used with reference to items, means one or more items. For example, “a number of different forms” is one or more different forms.

In this example, health monitoring system 202 can operate to monitor the health of component 204 in platform 203. As used herein, a “set of” when used with reference items means one or more items. In this illustrative example, component 204 can take a number of different forms. For example, component 204 can be selected from a group comprising a generator, generator bearings, a pump, a cooling system, a heat exchanger, an auxiliary power unit, a landing gear system, a wing, an in-flight entertainment system, a computer, or other types of components.

In this illustrative example, health monitoring system 202 comprises a number of different components. As depicted, health monitoring system 202 comprises computer system 212, neural network 205, and health analyzer 214.

Neural network 205 is a model comprising nodes organized into layers 220. These layers in neural network 205 operate to perform transformations on input data. These inputs can travel as signals through layers 220. In this example, layers 220 are fully connected layers. This means that each node in a given layer is connected to every node in a subsequent layer.

In this example, layers 220 include input layer 221, hidden layers 222, and output layer 223. Hidden layers 222 are layers 220 located between input layer 221 and output layer 223.

In this example, input layer 221 is connected to first layer 219 in hidden layers 222. In other words, first layer 219 is configured to receive sensor data 230 for the set of variables 231 for component 204 through input layer 221. The set of variables 231 can be selected from at least one of a voltage, a voltage phase, an acceleration or a vibration frequency, a current, a temperature, an acoustic wave, or other suitable variable.

In this example, neural network 205 is referred to as a deep learning neural network because of the presence of two or more of hidden layers 222.

In this example, input layer 221 in layers 220 in neural network 205 is to receive sensor data 230 for a set of variables 231 for component 204. Sensor system 263 is configured to generate sensor data 230. In this depicted example, sensor data 230 is generated from monitoring component 204. Thus, sensor data 230 can be used for monitoring or analysis of component 204. Sensor system 263 is comprised of a number of sensors 251. These sensors can include at least one of a temperature sensor, a light sensor, an accelerometer, a pressure sensor, a magnetic sensor, a voltage sensor, a current sensor, or other suitable types of sensors.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Sensor data 230 can take a number of different forms. For example, sensor data 230 can be selected from at least one of analog time series data or digital time series data. This data can be received in channels in which each channel represents data for a particular variable as generated by a particular sensor in sensors 251.

In this example, subsequent layer 224 is a layer within hidden layers 222. In one example, subsequent layer 224 can be last layer 225 in hidden layers 222 before output layer 223 in layers 220 in neural network 205. In this example, subsequent layer 224 is configured to receive condition indicator data 233 for a set of condition indicators 234.

In these illustrative examples, physics-based features that are identified as being important with respect to health status 235 for component 204 can be represented using a set of condition indicators 234. In other words, the set of condition indicators 234 can be selected as physics features identified as being relevant to the health of component 204. In these examples, condition indicators 234 can be derived from sensor data 230 for the set of variables 231 for component 204. In this illustrative example, a condition indicator is a value derived from sensor data 230 and can represent physical or operational parameters of component 204. In this illustrative example, the set of condition indicators 234 can be at least one condition indicator thought to be relevant to generator 240. For example, the set of condition indicators 234 can be selected from at least one of a bearing based energy, a ball energy, an inner race energy, an outer race energy, a generator frequency of vibrations for the generator, hydraulic pump frequency, a hydraulic pump piston pass frequency, side lube pump frequency, or other type of condition indicator.

In this illustrative example, condition indicator data 233 for the set of condition indicators 234 is generated using sensor data 230. The sensor data used to determine condition indicator data 233 can include data for other variables in variables 231 in addition to or in place of those variables in the set of variables 231. For example, sensor data 230 can include the speed of a shaft for a variable in the form of shaft speed for component 204 when component 204 takes the form of generator bearings 241 in generator 240. The condition indicator can be a speed threshold for a shaft indicating when the shaft speed is greater than desired based on the specification. For example, if the speed of the shaft is over 100 revolutions per minute (RPM) the condition indicator can be set to 1. If the speed of the shaft is equal to or less than 100 revolutions per minute, the condition indicator can be set to 0.

In other examples, the condition indicator can be determined through more complex calculations. Further, the condition indicator can be determined using multiple variables in variables 231.

With the use of condition indicator data 233 that is input into subsequent layer 224 after first layer 219, neural network 205 is physics informed neural network 206.

In this example, neural network 205 has been trained to predict health status 235 of component 204 using sensor data 230 for the set of variables 231 and the condition indicator data 233 for the set of condition indicators 234. In this example, this prediction is output from output layer 223 in response to receiving sensor data 230 and condition indicator data 233.

Health status 235 predicted by neural network 205 can take a number of different forms. In one illustrative example, health status 235 can be selected from a group comprising normal, caution, and warning. This status is for component 204. In one example, component 204 comprises generator bearings 241 located in generator 240.

Health analyzer 214 can be implemented in software, hardware, firmware, or a combination thereof. When software is used, the operations performed by health analyzer 214 can be implemented in program instructions configured to run on hardware, such as a processor unit. When firmware is used, the operations performed by health analyzer 214 can be implemented in program instructions and data and stored in persistent memory to run on a processor unit. When hardware is employed, the hardware can include circuits that operate to perform the operations in health analyzer 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, health analyzer 214 identifies sensor data 230 for the set of variables 231 from sensor system 263 monitoring component 204. Health analyzer 214 identifies condition indicator data 233 for the set of condition indicators 234 for component 204.

Health analyzer 214 inputs sensor data 230 into input layer 221. Health analyzer 214 also inputs condition indicator data 233 into subsequent layer 224. In this example, health analyzer 214 receives prediction of health status 235 of component 204 from output layer 223 for neural network 205 in response to inputting sensor data 230 and condition indicator data 233.

In this example, health analyzer 214 can perform a set of actions 250 using health status 235 predicted for component 204. The set of actions 250 can be selected from at least one of logging health status 235, generating a warning, scheduling maintenance for component 204; or halting operation of component 204.

In one illustrative example, health analyzer 214 can train neural network 205. For example, health analyzer 214 can identify sample sensor data 260 for the set of variables 231 and sample condition indicator data 261 for the set of condition indicators 234. With this example, health analyzer 214 can generate training dataset 262 using sample sensor data 260 for the set of variables 231 and sample condition indicator data 261 for the set of condition indicators 234. Health analyzer 214 can also include labels 271 in training dataset 262. Labels 271 can be generated by health analyzer 214 for sample sensor data 260 and sample condition indicator data 261. Labels 271 can be determined from knowing the health of component 204 at the time sample sensor data 260 was collected. These labels can also be used with sample condition indicator data 261 determined from sample sensor data 260. Health analyzer 214 can then train neural network 205 using training dataset 262.

In one illustrative example, component 204 can be generator bearings 241 in generator 240. With this example, health status 235 for generator bearings 241 can be predicted by neural network 205. Further, the prediction of the health status 235 can also indirectly indicate the health of generator 240. Other components other than generator bearings 241 within generator 240 can also affect the health of generator 240 with this example.

Further, with this example, the selection of subsequent layer within layers 220 can be based on the amount of importance to be given to condition indicators 234. In other words, subsequent layer 224 can be another layer in hidden layers 222 other than last layer 225. As subsequent layer 224 is selected to be closer to output layer 223, the importance of condition indicators 234 in determining health status 235 increases relative to the set of variables 231 input into first layer 219 via input layer 221.

In one illustrative example, one or more technical solutions are present that overcome a technical problem with predicting the health of components. As a result, one or more technical solutions may provide a technical effect using a neural network that receives sensor data for a set of variables generated from monitoring the components and a set of condition indicator data for condition indicators for the components. The condition indicator data is input at a later layer as compared to the sensor data. The neural network is configured such that this type of data input provides greater importance to the condition indicator data in predicting the health of the component.

Computer system 212 can be configured to perform at least one of the steps, operations, or actions described in the different illustrative examples using software, hardware, firmware, or a combination thereof. As a result, computer system 212 operates as a special purpose computer system in which health analyzer 214 in computer system 212 enables increased accuracy in predicting health states for components. In particular, health analyzer 214 transforms computer system 212 into a special purpose computer system as compared to currently available general computer systems that do not have health analyzer 214.

In the illustrative example, the use of health analyzer 214 in computer system 212 integrates processes into a practical application for monitoring the health of the components. In this example, health analyzer 214 in computer system 212 is directed to a practical application of processes integrated into health analyzer 214 in computer system 212 that enables performing a set of actions for the component.

For example, a set of actions can be taken with respect to the component using the prediction of the health state of a component. These actions can include at least one of logging the health status, generating a warning, scheduling maintenance for the component; halting operation of the components, or other suitable actions as a practical application of the process used to generate the prediction of the health state for the components.

The illustration of health monitoring environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, health status 235 can take other forms other than normal, caution, and warning. In another illustrative example, the health status can be a numerical label from 1 to 5 with one being good and five being poor. In another example, the status can be operating within tolerance for operating outside of tolerance.

In another illustrative example, health analyzer 214 monitors one or more components of the same type as component 204 using neural network 205. In yet another illustrative example, one or more neural networks can be present that have been trained to predict a health status for other types of components in platform 203 or in other platforms. In another example, health analyzer 214 can also be referred to as a controller.

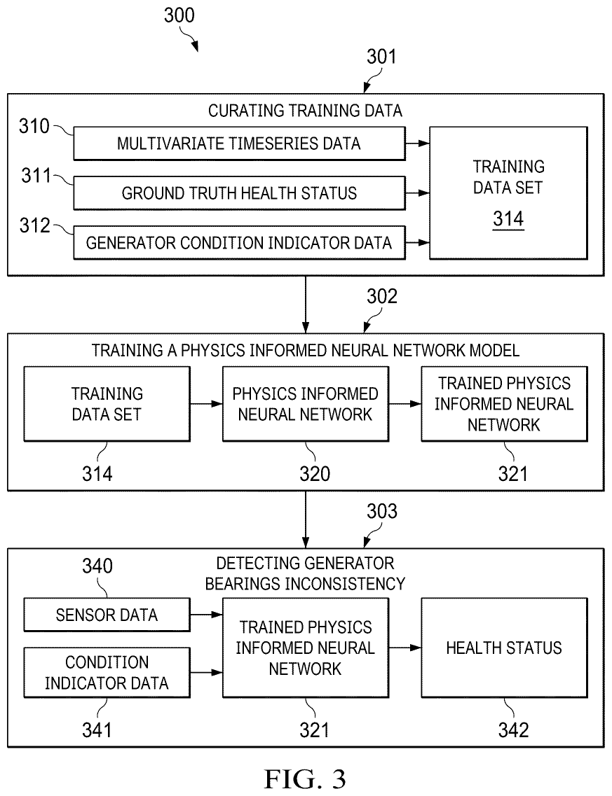

Turning now to FIG. 3, an illustration of a dataflow for training and using a physics informed neural network is depicted in accordance with an illustrative embodiment. In this illustrative example, a neural network in the form of a physics informed neural network can be trained and used to predict the health status for a component such as generator bearings 241 in FIG. 2. Dataflow 300 can be implemented using health analyzer 214 in FIG. 2.

In this illustrative example, dataflow 300 comprises curating training data in block 301; training a physics informed neural network in block 302, and detecting the generator bearings inconsistency in block 303. In this example, multivariate time series data 310 is identified. In this example, multiple time series windows with a selected length are identified. In this example, this time series data can be analog multivariate time series data and is an example of an implementation for sample sensor data 260 for the set of variables 231 in FIG. 2. The time series data can be generated from sensors monitoring a generator sensor. Initial data is generated for multivariate time series data 310 with grease. Additional runs of the generator can be performed with the grease removed. The sensor data from this operation of the generator is also in multivariate time series data 310. In this illustrative example, the generator sensor data collected for multivariate time series data 310 can include, for example, accelerometer X, accelerometer Y, accelerometer Z, voltage Phase A, voltage Phase B, voltage Phase C, 1/Rev vibration, and temperature. In this example, acceleration and voltage phase can be detected from multiple locations. 1Rev/vibration is a vibration measurement made once per revolution of a shaft.

Additionally, ground truth health status 311 is identified for each of the time series windows in multivariate time series data 310. For example, ground truth health status 311 can be greased or can lack grease in the generator bearings.

Additionally, generator condition indicator data 312 is identified for time windows corresponding to multivariate time series data 310. Thus, condition indicator data 233 also corresponds to ground truth health status 311. In this example, these condition indicators represent physics knowledge relating to the health of generator bearings. Generator condition indicator data 312 can include data relating to varying energy and shocked pulsed energy. These condition indicators can be derived or calculated using the sensor data in multivariate time series data 310 or other data generated from monitoring the generator.

In this illustrative example, multivariate time series data 310, generator condition indicator data 312, and ground truth health status 311 form training dataset 314. In training a physics informed neural network in block 302, physics informed neural network 320 is identified for training. This model is trained using training dataset 314 to form trained physics informed neural network 321.

Next in detected generator bearings inconsistency in block 303, sensor data 340 and condition indicator data 341 are identified. This data is input into trained physics informed neural network 321. In this example, sensor data 340 is input into an input layer in trained physics informed neural network 321. Condition indicator data 341 is input into a subsequent layer after the input layer and prior to the output layer in trained physics informed neural network 321. In response to receiving this data, this model outputs a prediction of health status 342.

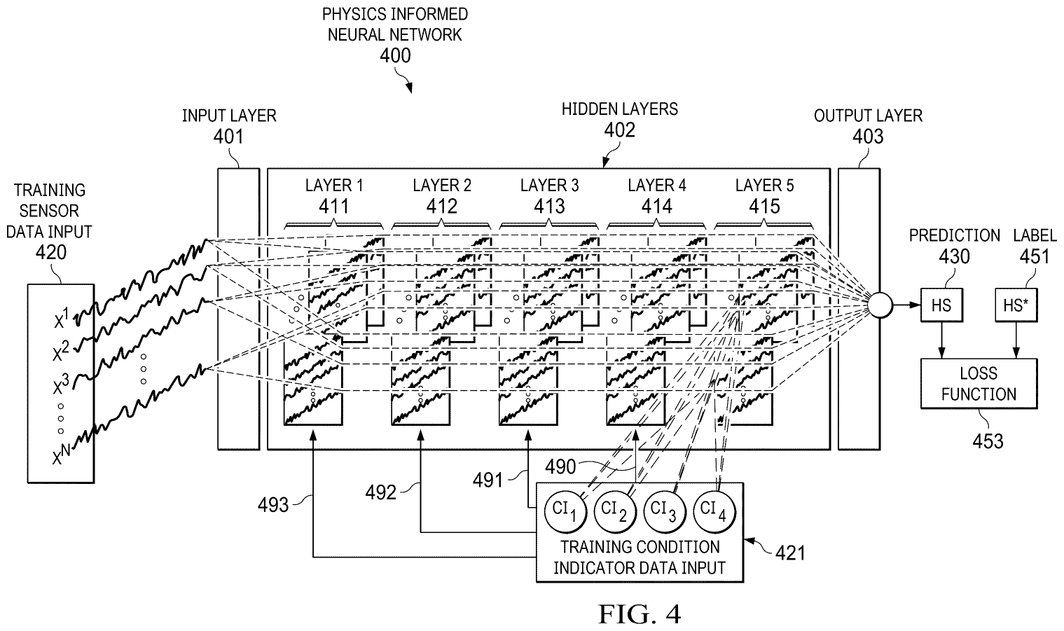

Turning next to FIG. 4, an illustration of a diagram of training a physics informed neural network is depicted in accordance with an illustrative embodiment. In this example, physics informed neural network 400 is an example of an implementation for physics informed neural network 206 in FIG. 2. This neural network can be trained using dataflow 300 in FIG. 3.

As depicted, physics informed neural network 400 comprises input layer 401, hidden layers 402, and output layer 403. Hidden layers 402 include layer 1 411, layer 2 412, layer 3 413, layer 4 414, and layer 5 415. These layers are fully connected to each other.

In training physics informed neural network 400, training sensor data input 420 is input into input layer 401. In the training phase, training sensor data input 420 comprises training data from a training dataset such as sample sensor data 260 in training dataset 262 in FIG. 2 and multivariate time series data 310 in training dataset 314 in FIG. 3.

Training sensor data input 420 comprises multivariate time series data such as multivariate time series data 310 in FIG. 3. This multivariate time series data is for a number of variables monitored for a component such as generator bearings. This data can be monitored using analog channels for a sensor system monitoring the generator bearings. For example, training sensor data input 420 can include accelerometer X, accelerometer Y, accelerometer Z, voltage Phase A, voltage Phase B, voltage Phase C, 1/Rev vibration, and temperature.

In addition to training physics informed neural network 400, training condition indicator data input 421 is also input into physics informed neural network 400. In this example, training condition indicator data input 421 comprises training data such as sample condition indicator data 261 and training dataset 262 in FIG. 2 and generator condition indicator data 312 in training dataset 314 in FIG. 3.

As depicted, training condition indicator data input 421 is not input into input layer 401 as with training sensor data input 420. Instead, training condition indicator data input 421 is input into one of hidden layers 402 after first layer in hidden layers 402, which is layer 1 411. In this example, the hidden layer is layer 5 415. This layer is an example of subsequent layer 224 in FIG. 2 and is an example of last layer 225 in FIG. 2. Training condition indicator data input 421 is concatenated with latent variables in layer 5 415. For example, training condition indicator data input 421 can be joined with the hidden variables in this layer using a vector or tensor that serves as an input into the hidden layer.

The selection of a subsequent layer later in physics informed neural network 400 enables increasing the importance or emphasis of data for condition indicators. In this example, the subsequent layer is selected to be one later than layer 1 411 and before output layer 403 as depicted by arrow 490, arrow 491, arrow 492, and arrow 493.

In this illustrative example, physics informed neural network 400 processes training sensor data input 420 and training condition indicator data input 421 and outputs prediction 430 from output layer 403. Prediction 430 is a prediction basic form of a health status to predict the health of the generator bearings. When the components are generator bearings, the prediction can be green, yellow, or red in one example. Green represents that the generator bearings are in good condition grease. Yellow indicates that the bearings are in good condition but not greased. Red indicates that the bearings are in poor condition and not greased. In this example, loss function 453 is used to determine the accuracy of prediction 430. Loss function 453 receives prediction 430 and label 451 as inputs. In this example, label 451 is the health status for the generator bearings for the particular training data in training sensor data input 420 and training condition indicator data input 421. Label 451 can be, for example, a label in labels 271 used with training dataset 262 or a label from ground truth health status 311 in FIG. 3.

Loss function 453 be implemented using a cost function that is the mean squared error between the true health status represented by label 451 and predicted health status in prediction 450. The weights and biases in physics informed neural network 400 are updated until convergence occurs from solving a regression problem. In this example, the weights and biases are adjusted to reduce the reference or loss determined by loss function physics informed neural network 400.

After training, physics informed neural network 400 can be used to generate prediction 430 for the generator bearings.

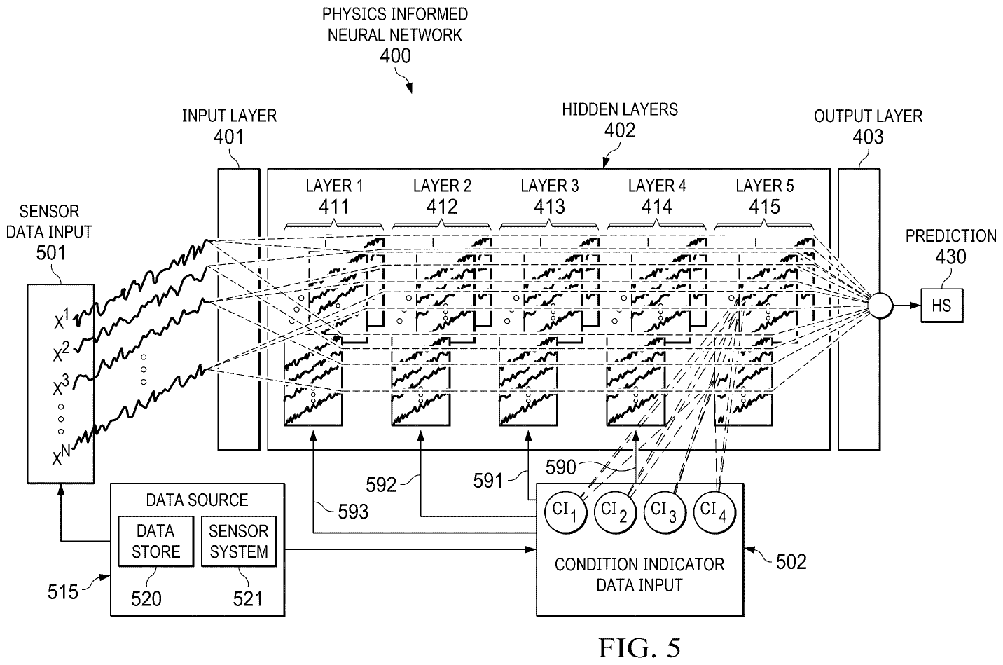

With reference next to FIG. 5, an illustration of a diagram of training a physics informed neural network is depicted in accordance with an illustrative embodiment. In the illustrative examples, the same reference numeral may be used in more than one figure. This reuse of a reference numeral in different figures represents the same element in the different figures.

In this example, physics informed neural network 400 has been trained and can be used to predict the health generator bearings. As depicted, actual sensor data is now used in place of the training data. In this example, the sensor data comprises sensor data input 501 and condition indicator data input 502 rather than training data in a training dataset. Also in this example, loss function 453 is not needed.

In this illustrative example, physics informed neural network 400 can operate to generate prediction 430 in a number of different ways. Physics informed neural network 400 can receive sensor data comprising sensor data input 501 and condition indicator data input 502 from data source 515. In this illustrative example, data source 515 is data store 520. Data store 520 is a location where data is collected. Data store 520 can be, for example, a database, a file, or other data structure for which data can be collected. In this example, prediction 430 is time subsequent from when the sensor data was generated.

In another illustrative example, data source 515 is sensor system 521. Sensor system 521 generates sensor data that is used as sensor data input 501. Additionally, the sensor data generated by sensor system 521 can be processed to create condition indicator data input 502. With this example, the sensor data is sent as quickly as possible to physics informed neural network 400 such that prediction 430 generated in real time or as close to real time as possible.

This illustrative example, condition indicator data input 502 is sent into layer 5 415. This input is sent into the same layer as training condition indicator data input 421 in FIG. 4. In other illustrative examples, this input can be sent into other layers in hidden layers 402 such as indicated by arrow 590, arrow 591, arrow 592, and arrow 593. The selection of layer 1 411 would result in training condition indicator input 421 having the same importance as training sensor data input 420.

In these examples, generating prediction 430 cannot be performed quickly enough by a human operator attempting to process the sensor data input 501 and condition indicator data input 502. In other words, the human operator cannot perform the processing of this input data using weights and biases in the layers in physics informed neural network 400 as performed by this neural network. This analysis prediction cannot be generated quickly enough in real time to perform an action that may be needed. Further, even when analyzing a later time, prediction 430 cannot be made quickly enough by the human operator to perform other actions such as scheduling maintenance or taking the component out of use to increase safety in a timely manner. When the component is located in a fleet of platforms such as 10 commercial airplanes, 50 commercial airplanes, or hundreds of commercial airplanes, the analysis needed for the prediction is infeasible to be performed by a human operator.

The illustration of training and use of physics informed neural network 400 is provided as an example of one implementation for training and using a physics informed neural network. This example is not meant to limit the manner in which physics informed neural networks can be trained and implemented in other examples. For example, physics informed neural network 400 can be trained and used to predict the health of other types of components of the generator bearings. For example, physics informed neural network 400 can be trained to predict the health of a generator, an in-flight entertainment system, a pump, or some other suitable components. In another illustrative example, when other numbers of layers to be present in addition to or in place of the five hidden layers shown for physics informed neural network 400. For example, another physics informed neural network other numbers of hidden layers 402 such as have three layers, 12 layers, 17 layers, or some other number of hidden layers.

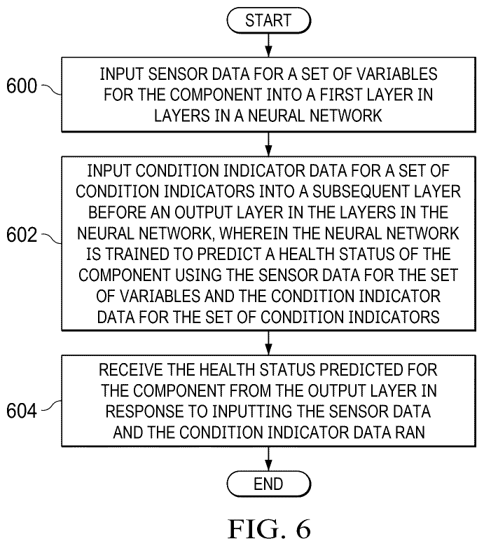

Turning next to FIG. 6, an illustration of a flowchart of a process for monitoring the health of a component is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in health analyzer 214 in computer system 212 in FIG. 2.

The process begins by inputting sensor data for a set of variables for the component into a first layer in layers in a neural network (operation 600). The process inputs condition indicator data for a set of condition indicators into a subsequent layer before an output layer in the layers in the neural network, wherein the neural network is trained to predict a health status of the component using the sensor data for the set of variables and the condition indicator data for the set of condition indicators (operation 602).

The process receives the health status predicted for the component from the output layer in response to inputting the sensor data and the condition indicator data ran (operation 604). The process terminates thereafter.

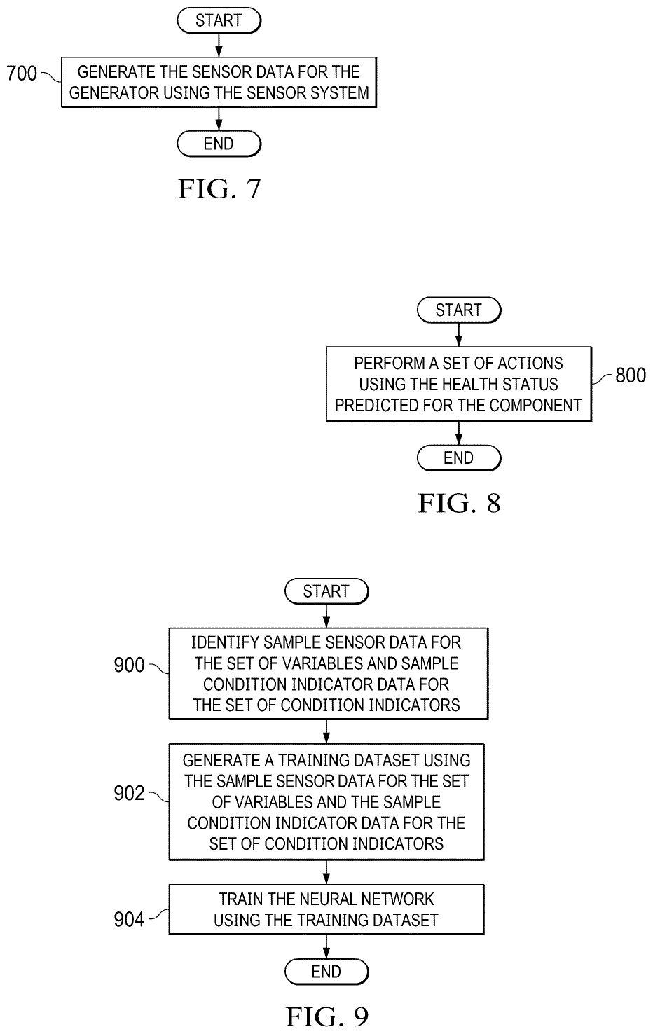

With reference to FIG. 7, an illustration of a flowchart of a process for generating sensor data is depicted in accordance with an illustrative embodiment. The process in this figure is an example of an additional operation that can be performed with the operations in FIG. 6.

The process generates the sensor data for the generator using the sensor system (operation 700). The process terminates thereafter.

Next in FIG. 8, an illustration of a flowchart of a process for performing a set of actions is depicted in accordance with an illustrative embodiment. The process in this figure is an example of an additional operation that can be performed with the operations in FIG. 6.

The process performs a set of actions using the health status predicted for the component (operation 800). The process terminates thereafter. Operation 800 is an example of a practical application of determining the health status for a component.

In other words, a set of actions can be performed for the component based on the health status predicted for the component. For example, the set of actions is selected from at least one of logging the health status, generating a warning, scheduling maintenance for the generator bearings; or halting operation of the generator in which the generator bearings are located.

With reference next to FIG. 9, an illustration of a flowchart of a process for training a neural network to monitor the health of a component is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in health analyzer 214 in computer system 212 in FIG. 2.

The process begins by identifying sample sensor data for the set of variables and sample condition indicator data for the set of condition indicators (operation 900). The process generates a training dataset using the sample sensor data for the set of variables and the sample condition indicator data for the set of condition indicators (operation 902).

The process trains the neural network using the training dataset (operation 904). The process terminates thereafter.

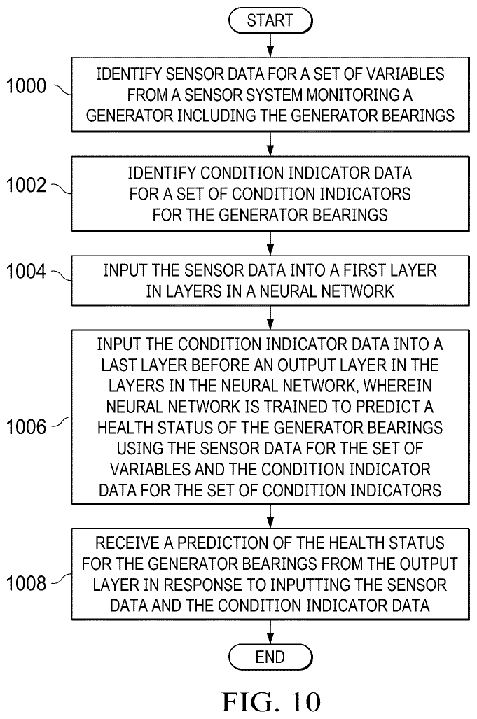

Turning next to FIG. 10, an illustration of a flowchart of a process for monitoring the health of generator bearings is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in health analyzer 214 in computer system 212 in FIG. 2.

The process begins by identifying sensor data for a set of variables from a sensor system monitoring a generator including the generator bearings (operation 1000). The process identifies condition indicator data for a set of condition indicators for the generator bearings (operation 1002).

The process inputs the sensor data into a first layer in layers in a neural network (operation 1004). The process inputs the condition indicator data into a last layer before an output layer in the layers in the neural network, wherein the neural network is trained to predict a health status of the generator bearings using the sensor data for the set of variables and the condition indicator data for the set of condition indicators (operation 1006).

The process receives a prediction of the health status for the generator bearings from the output layer in response to inputting the sensor data and the condition indicator data (operation 1008). The process terminates thereafter.

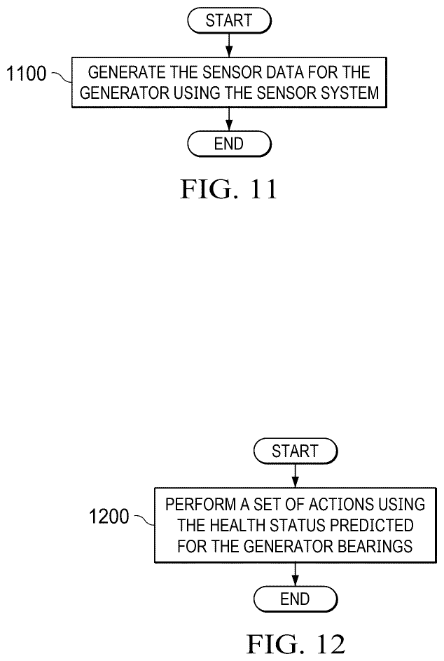

With reference to FIG. 11, an illustration of a flowchart of a process for generating sensor data is depicted in accordance with an illustrative embodiment. The process in this figure is an example of an additional operation that can be performed with the operations in FIG. 10.

The process generates the sensor data for the generator using the sensor system (operation 1100). The process terminates thereafter.

Turning to FIG. 12, an illustration of a flowchart of a process for performing a set of actions is depicted in accordance with an illustrative embodiment. The process in this figure is an example of an additional operation that can be performed with the operations in FIG. 10.

The process performs a set of actions using the health status predicted for the generator bearings (operation 1200). The process terminates thereafter. Operation 1200 is an example of a practical application of determining the health status for the generator bearings.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

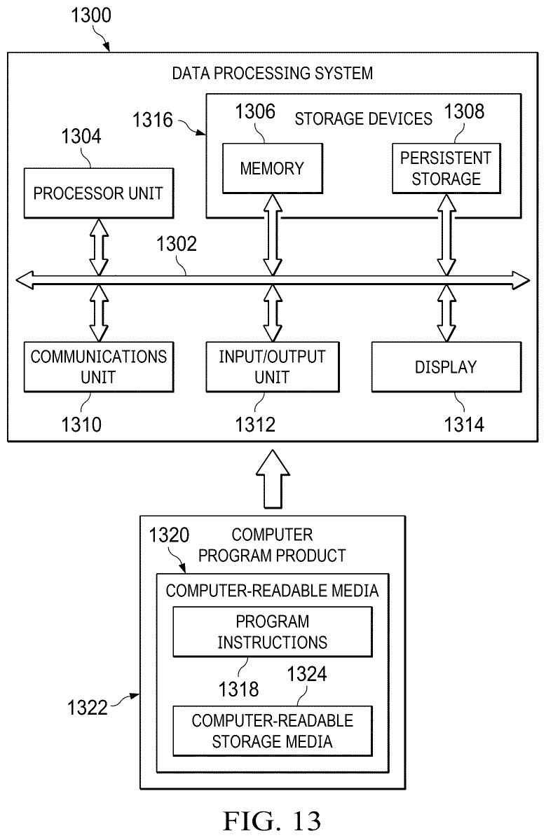

Turning now to FIG. 13, a block diagram of a data processing system is depicted in accordance with an illustrative embodiment. Data processing system 1300 can also be used to implement computer system 212 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer-readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer-readable program instructions that can be read and executed by a processor in processor unit 1304. The program instructions in the different embodiments can be embodied on different physical or computer-readable storage media, such as memory 1306 or persistent storage 1308.

Program instructions 1318 are located in a functional form on computer-readable media 1320 that is selectively removable and can be loaded onto or transferred to data processing system 1300 for execution by processor unit 1304. Program instructions 1318 and computer-readable media 1320 form computer program product 1322 in these illustrative examples. In the illustrative example, computer-readable media 1320 is computer-readable storage media 1324.

Computer-readable storage media 1324 is a physical or tangible storage device used to store program instructions 1318 rather than a medium that propagates or transmits program instructions 1318. Computer-readable storage media 1324 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 1324, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1318 can be transferred to data processing system 1300 using a computer-readable signal media. The computer-readable signal media are signals and can be, for example, a propagated data signal containing program instructions 1318. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1320” can be singular or plural. For example, program instructions 1318 can be located in computer-readable media 1320 in the form of a single storage device or system. In another example, program instructions 1318 can be located in computer-readable media 1320 that is distributed in multiple data processing systems. In other words, some instructions in program instructions 1318 can be located in one data processing system while other instructions in program instructions 1318 can be located in another data processing system. For example, a portion of program instructions 1318 can be located in computer-readable media 1320 in a server computer while another portion of program instructions 1318 can be located in computer-readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

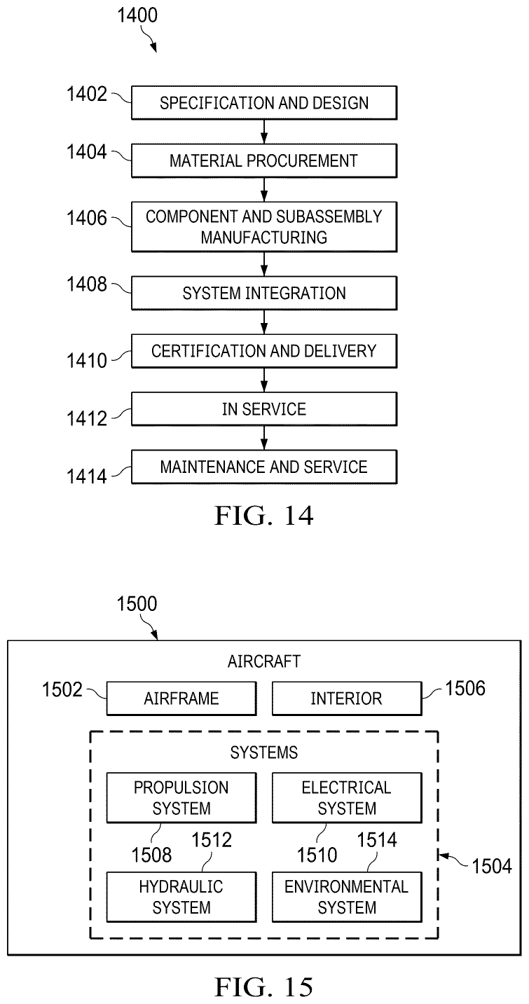

Illustrative embodiments of the disclosure may be described in the context of aircraft manufacturing and service method 1400 as shown in FIG. 14 and aircraft 1500 as shown in FIG. 15. Turning first to FIG. 14, an illustration of an aircraft manufacturing and service method is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 in FIG. 15 takes place. Thereafter, aircraft 1500 in FIG. 15 can go through certification and delivery 1410 in order to be placed in service 1412. While in service 1412 by a customer, aircraft 1500 in FIG. 15 is scheduled for routine maintenance and service 1414, which may include modification, reconfiguration, refurbishment, and other maintenance or service.

Each of the processes of aircraft manufacturing and service method 1400 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of an aircraft is depicted in which an illustrative embodiment may be implemented. In this example, aircraft 1500 is produced by aircraft manufacturing and service method 1400 in FIG. 14 and may include airframe 1502 with plurality of systems 1504 and interior 1506. Examples of systems 1504 include one or more of propulsion system 1508, electrical system 1510, hydraulic system 1512, and environmental system 1514. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1400 in FIG. 14.

In one illustrative example, components or subassemblies produced in component and subassembly manufacturing 1406 in FIG. 14 can be fabricated or manufactured in a manner similar to components or subassemblies produced while aircraft 1500 is in service 1412 in FIG. 14. As yet another example, one or more apparatus embodiments, method embodiments, or a combination thereof can be utilized during production stages, such as component and subassembly manufacturing 1406 and system integration 1408 in FIG. 14. One or more apparatus embodiments, method embodiments, or a combination thereof may be utilized while aircraft 1500 is in service 1412, during maintenance and service 1414 in FIG. 14, or both. The use of a number of the different illustrative embodiments may substantially expedite the assembly of aircraft 1500, reduce the cost of aircraft 1500, or both expedite the assembly of aircraft 1500 and reduce the cost of aircraft 1500.

In this illustrative example, health monitoring system 130 in FIG. 1 and health monitoring system 202 in FIG. 2 are examples of health monitoring systems that can be used during in service 1412 to determine when maintenance may be needed. This system can be used in real time on aircraft 1500 to determine when maintenance or other actions may be needed with respect to various components of aircraft 1500. Further, the health monitoring systems can be used during maintenance and service 1414 to process sensor data collected during in service 1412 to determine whether maintenance is needed. This maintenance can include reconfiguration, refurbishment, replacement, repair, and other maintenance or service.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A generator health monitoring system for a generator, wherein the generator health monitoring system comprises:
a computer system;
a neural network in the computer system, wherein the neural network comprises:
layers;
a first layer in the layers in the neural network, wherein the first layer is configured to receive sensor data for a set of variables for generator bearings in the generator; and
a last layer before an output layer in the layers in the neural network, wherein the last layer is configured to receive condition indicator data for a set of condition indicators and wherein the neural network is trained to predict a health status of the generator bearings using the sensor data for the set of variables and the condition indicator data for the set of condition indicators; and
a health analyzer in the computer system, wherein the health analyzer is configured to:
identify the sensor data for the set of variables from a sensor system monitoring the generator including the generator bearings;
identify the condition indicator data for the set of condition indicators for the generator bearings;
input the sensor data into the first layer;
input the condition indicator data into the last layer; and
receive the prediction of the health status of the generator bearings from the output layer for the neural network in response to inputting the sensor data and the condition indicator data.

2. The generator health monitoring system of claim 1 further comprising:
the sensor system configured to generate the sensor data for the generator.

3. The generator health monitoring system of claim 1, wherein the health analyzer is configured to:
perform a set of actions using the health status predicted for the generator bearings.

4. The generator health monitoring system of claim 3, wherein the set of actions is selected from at least one of logging the health status, generating a warning, scheduling maintenance for the generator bearings; or halting operation of the generator in which the generator bearings are located.

5. The generator health monitoring system of claim 1, wherein the neural network is a physics informed neural network.

6. The generator health monitoring system of claim 1, wherein the health status of the generator bearings is selected from a group comprising normal, caution, and warning.

7. The generator health monitoring system of claim 1, wherein the set of condition indicators is selected from at least one a bearing based energy, a ball energy, an inner race energy, an outer race energy, a generator frequency of vibrations for the generator, hydraulic pump frequency, a hydraulic pump piston pass frequency, or side lube pump frequency.

8. The generator health monitoring system of claim 1, wherein the set of variables is selected from at least one of a voltage, a voltage phase, an acceleration or a vibration frequency, a current, a temperature, or an acoustic wave.

9. The generator health monitoring system of claim 1, wherein the sensor data for the set of variables is selected from at least one of analog time series data or digital time series data.

10. The generator health monitoring system of claim 1, wherein the layers are fully connected layers.

11. The generator health monitoring system of claim 1, wherein the health analyzer in the computer system is configured to:
identify sample sensor data for the set of variables and sample condition indicator data for the set of condition indicators;
generate a training dataset using the sample sensor data for the set of variables and the sample condition indicator data for the set of condition indicators; and
train the neural network using the training dataset.

12. The generator health monitoring system of claim 1, wherein the generator bearings are located in a platform selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

13. A health monitoring system comprising:
a computer system;
a neural network in the computer system, wherein the neural network comprises:
layers;
a first layer in the layers in the neural network, wherein the first layer is configured to receive sensor data for a set of variables for a component; and
a subsequent layer before an output layer in the layers in the neural network, wherein the subsequent layer is configured to receive condition indicator data for a set of condition indicators and wherein the neural network is trained to predict a health status of the component using the sensor data for the set of variables and the condition indicator data for the set of condition indicators; and
a health analyzer in the computer system, wherein the health analyzer is configured to:
input the sensor data into the first layer;
input the condition indicator data into the subsequent layer; and
receive the health status predicted for the component from the output layer in response to inputting the sensor data and the condition indicator data.

14. The health monitoring system of claim 13, wherein the health analyzer is configured to:
perform a set of actions using the health status predicted for the component.

15. The health monitoring system of claim 13, wherein the component is selected from a group comprising a generator, the generator bearings, a pump, a cooling system, a heat exchanger, an auxiliary power unit, a landing gear system, a wing, an in-flight entertainment system, and a computer.

16. The health monitoring system of claim 14, wherein the component is located in a platform selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

17. A method for monitoring a health of generator bearings, the method comprising:
identifying sensor data for a set of variables from a sensor system monitoring a generator including the generator bearings;
identifying condition indicator data for a set of condition indicators for the generator bearings;
inputting the sensor data into a first layer in layers in a neural network;
inputting the condition indicator data into a last layer before an output layer in the layers in the neural network, wherein the neural network is trained to predict a health status of the generator bearings using the sensor data for the set of variables and the condition indicator data for the set of condition indicators; and
receiving a prediction of the health status for the generator bearings from the output layer in response to inputting the sensor data and the condition indicator data.

18. The method of claim 17 further comprising:
generating the sensor data for the generator bearings using the sensor system.

19. The method of claim 17 further comprising:
performing a set of actions using the health status predicted for the generator bearings.

20. The method of claim 19, wherein the set of actions is selected from at least one of logging the health status, generating a warning, scheduling maintenance for the generator bearings; or halting operation of the generator in which the generator bearings are located.

21. The method of claim 17, wherein the neural network is a physics informed neural network.

22. The method of claim 17, wherein the health status of the generator bearings is selected from a group comprising normal, caution, and warning.

23. The method of claim 17, wherein the set of condition indicators is selected from at least one of a bearing based energy, a ball energy, an inner race energy, an outer race energy, a generator frequency of vibrations for the generator, hydraulic pump frequency, a hydraulic pump piston pass frequency, or side lube pump frequency.

24. The method of claim 17, wherein the set of variables is selected from at least one of a voltage, a voltage phase, an acceleration, a current, a temperature, a vibration frequency, or an acoustic emission.

25. The method of claim 17, wherein the sensor data for the set of variables is selected from at least one of analog times series data or digital time series data.

26. The method of claim 17, wherein the layers are fully connected layers.

27. The method of claim 17 further comprising:
identifying sample sensor data for the set of variables and sample condition indicator data for the set of condition indicators;
generating a training dataset using the sample sensor data for the set of variables and the sample condition indicator data for the set of condition indicators; and
training the neural network using the training dataset.

28. The method of claim 17, wherein the generator bearings are located in a platform selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, and a building.

29. A method for monitoring a health of a component, the method comprising:
inputting sensor data for a set of variables for the component into a first layer in layers in a neural network;
inputting condition indicator data for a set of condition indicators into a subsequent layer before an output layer in the layers in the neural network, wherein the neural network is trained to predict a health status of the component using the sensor data for the set of variables and the condition indicator data for the set of condition indicators; and
receiving the health status predicted for the component from the output layer in response to inputting the sensor data and the condition indicator data.
